(19) United States
(12) Patent Application Publication
(10) Pub. No.: US 2018/0071947 A1
(43) Pub. Date: Mar. 15, 2018

(54) METHOD FOR BONDING LIGNOCELLULOSIC MATERIAL WITH PHENOLIC RESIN AND GASEOUS CARBON DIOXIDE

(71) Applicant: Hexion Inc., Columbus, OH (US)

(72) Inventors: John D. SLAYTER, Alexandria, LA (US); Dale L. Leeper, Lufkin, TX (US); Adam D. Bowden, Huntington, TX (US)

(21) Appl. No.: 15/703,474

(22) Filed: Sep. 13, 2017

Related U.S. Application Data
(60) Provisional application No. 62/394,609, filed on Sep. 14, 2016.

(51) Int. Cl. B27N 3/24; B27N 3/08; B27N 3/18

(52) U.S. Cl. CPC B27N 3/24; B27N 3/18; B27N 3/08

(57) ABSTRACT

Lignocellulosic materials can be press formed into mats using heated carbon dioxide and a phenol formaldehyde resin. Employing this method allows for a reduction or even elimination of the use of steam. The carbon dioxide, along with other gases may be recovered for recycle or disposal thus reducing the environmental footprint the process.

### RELATED APPLICATION DATA

This application claims benefit to U.S. Provisional Application No. 62/394,609, filed Sep. 14, 2016, of which the entire contents of the application are incorporated by reference herein.

### BACKGROUND

### Field of the Disclosure

The invention relates to bonding lignocellulosic material. The invention particularly relates to oriented strand board.

### Background of the Disclosure

Panel products which use phenol formaldehyde resins as binders for lignocellulosic materials are usually manufactured in a hot press which is heated by steam, hot oil, or electricity. The cellulosic components of the panels are usually in the form of chips, strands or veneers. It is common in the art to refer to the matrix of binder and cellulosic components as a mat.

In the production of such mats, the cycle time of the process is critical. Stated another way, processes wherein the mats must spend too long a time in the press are usually not very economical.

One method of decreasing cycle time by speeding the cure of the resin is to inject steam into the mats. This is particularly useful in making fiberboard where the wood particles are very small and pliable. Unfortunately, steam injection is not quite so desirable when making mats using larger wood particles. It is believed that the interaction of condensate from the steam with the liquefied resins results in a dilution of the phenol formaldehyde resin prior to the beginning of gelation.

One solution to the dilution of the resin is the introduction of carbon dioxide to components that are coated with resin. This was disclosed in U.S. Pat. No. 5,902,442; the contents of which are incorporated herein in their entirety.

### SUMMARY

In one aspect, the invention is a method for press bonding lignocellulosic material with phenol formaldehyde resins and carbon dioxide where the carbon dioxide is heated before being introduced into a lignocellulosic mat.

In another aspect, the invention is a system for making press bonded lignocellulosic mats wherein at least some heating is introduced into the system by the introduction of heated carbon dioxide into or upstream of the press.

In still another aspect the invention is a system for making press bonded lignocellulosic mats where no steam is introduced into the system.

Another aspect of the invention is a system for making press bonded lignocellulosic mats where carbon dioxide is introduced into the system at or upstream from the press and then recovered for recycling downstream from the press.

In another aspect, the invention is a method for press bonding lignocellulosic material with phenol formaldehyde resins and carbon dioxide wherein the temperature and/or amount of carbon dioxide is used to prevent water condensation on or within the lignocellulosic material.

### BRIEF DESCRIPTION OF THE DRAWINGS

FIG. 1 is a box plot of mean bond strength with combination of factors including gas type, gas temperature, gas flow, and press time;

FIG. 2 is a box plot of mean bond strength of gas type, gas temperature, and gas flow rate 1; and

FIG. 3 a box plot of mean bond strength across gas type, gas flow rate, and press time.

### DESCRIPTION

In one embodiment, the invention is a method for press bonding lignocellulosic material with phenol formaldehyde resins and carbon dioxide where the carbon dioxide is heated before being introduced into a lignocellulosic mat. Lignocellulosic materials useful with the method of the application include, but are not limited to aspen, oak, hardwood, eucalyptus, acacia, birch, palm wood, rubber wood, mulberry wood, FSC certified wood species, coir, jute, seagrass, straw, and the like. Wood laminate sheets may also be employed.

For the purposes of the present application, the term heated or hot carbon dioxide means carbon dioxide having a temperature of at least 125° C. This term is further defined below.

Phenol formaldehyde resins useful with the methods of the application include but are not limited to those prepared under aqueous reaction conditions at a formaldehyde to phenol mole ratio (F:P) in the range of 1.5:1 to 3.0:1 (usually 2.25:1 to 2.65:1) and having a weight average molecular weight in a range of 200 to 100,000. A particularly suitable aqueous phenol-formaldehyde resin can be made at a formaldehyde: phenol (F:P) mole ratio in the range of about 2.35:1 to 2.5:1.

A suitable aqueous phenol-formaldehyde resin composition can be produced by reacting phenol and formaldehyde in water under an alkaline condition so as to yield a phenol-formaldehyde resole resin having a weight average molecular weight of between about 200 and 100,000, preferably between 1,000 and 20,000. Suitable methods for synthesizing an aqueous phenol-formaldehyde resole resin composition include both single step batch processes, or “programmed” processes (i.e., staged addition). In its broadest aspects, the present invention is not limited to any particular way for making the aqueous phenol-formaldehyde resin composition.

Such an aqueous phenol-formaldehyde resole resin may have a typical resin solids content of about 25% to 75% by weight, usually from about 30% to 60% solids by weight.

Conveniently, a batch process can be used to synthesize a suitable aqueous phenol-formaldehyde resole resin composition by single-stage alkaline condensation of phenol and formaldehyde under a vacuum reflux at a temperature between 60 and 100° C., usually above 70° C., and often above 80° C. The molar ratio of formaldehyde to phenol for making the aqueous phenol-formaldehyde resin composition may be in the range of 1.5:1 to 3.0:1 (usually 2.25:1 to 2.65:1), preferably in the range of 2.35 to 2.50.

A phenol-formaldehyde resole resin can be further modified by the post addition of caustic, sodium hydroxide.

Phenol used for making phenol-formaldehyde resins for the binder used in accordance with the present invention may be replaced, partially or totally in some cases, with other phenolic compounds un-substituted at either the two ortho positions or at one ortho and the para position. These unsubstituted positions are necessary for the desired polymerization reaction(s) to occur. Other phenol compounds substituted in these positions may be used in lesser quantities (e.g., up to about 10 weight % of the phenol) as it is known in the art to control molecular weight by a chain termination reaction using such phenolic compounds. Any one, all, or none of the remaining carbon atoms of the phenol ring can be substituted in a conventional fashion. The nature of the substituents can vary widely, and it is only necessary that the substituent not interfere in the polymerization of the aldehyde with the phenol at the ortho and/or para positions. Substituted phenols which optionally can be employed in the formation of the phenol-formaldehyde resole resin include alkyl substituted phenols, aryl substituted phenols, cycloalkyl substituted phenols, alkenyl substituted phenols, alkoxy substituted phenols, aryloxy substituted phenols, and halogen substituted phenols, the foregoing substituents possibly containing from 1 to 26, and usually from 1 to 9, carbon atoms.

Specific examples of suitable phenolic compounds for replacing a portion or all of the phenol used in preparing the phenol-formaldehyde resin compositions used in the present invention include: bis-phenol A, bis-phenol F, o-cresol, m-cresol, p-cresol, 3, 5-5 xylenol, 3,4-xylenol, 3,4,5-trimethylphenol, 3-ethyl phenol, 3,5-diethyl phenol, p-butyl phenol, 3,5-dibutyl phenol, p-amyl phenol, p-cyclohexyl phenol, p-octyl phenol, 3,5 dicyclohexyl phenol, p-phenyl phenol, p-phenol, 3,5-dimethoxy phenol, 3,4,5 trimethoxy phenol, p-ethoxy phenol, p-butoxy phenol, 3-methyl-4-methoxy phenol, p-phenoxy phenol, naphthol, anthranol and substituted derivatives thereof.

The aqueous phenol-formaldehyde resin composition, e.g., resole resin composition, usually has an alkalinity, i.e., contains a base, in the range of 0.5% to about 15%, more usually in the range of 1% to 12%, and particularly in the range of 2% to 8%, based on the weight of the aqueous resin composition, when the base is sodium hydroxide. If a different base is used, the alkalinity content should be proportioned to be equivalent on a molar weight basis to the above noted range based on sodium hydroxide. For example, to attain the equivalent of an alkalinity of 6% sodium hydroxide, i.e., 6 grams of sodium hydroxide in 100 grams of aqueous resin, about 8.4 grams of potassium hydroxide in 100 grams of the resin solution would be required. The base may be an alkali metal or alkaline earth metal compound such as a hydroxide, a carbonate, or an oxide.

Other phenol formaldehyde resins may also be used. For example novolac resins may be used. Any resin known to be useful by those of ordinary skill in the art of preparing lignocellulosic mats may be used with the methods of the application.

The method of the application includes press bonding lignocellulosic materials. Exemplary lignocellulosic materials include products such as plywood, laminated veneer lumber (LVL), oriented strand lumber (OSL), oriented strand board (OSB), particleboard, medium density fiber board, hardboard and the like.

Generally speaking, these materials are prepared by combining a binder resin with cellulose components to form a stack or mat which is then consolidated in a hot platen press to cure the binder resin. Systems useful for making such products include other elements. For example, such systems may may include mixers to include/incorporate additives such as waxes with the cellulosic components, steam injection units, mixers for combining the cellulosic materials with binders, conveying components, mat removal components, and the like.

Since the method of the application is useful for making so many different types of products, the amounts of cellulosic materials, resins, and other additives used will vary with the product being produced. One of ordinary skill in the art is well-versed in the operation of their specific systems in making lignocellulosic articles.

While not wishing to be bound by any theory, it is nevertheless believed that by employing carbon dioxide that has been heated prior to being introduced to the cellulosic mat for purposes of curing, that the above stated problem with dilution of resin can be avoided. Further, employing the heated carbon dioxide improves bond strength compared to an otherwise similar system employing unheated carbon dioxide. Another possible reason for the improvement observed is that heating the carbon dioxide increases the surface area reaction rate of the binder curing on the cellulosic substrate.

In one embodiment, the method of the application is employed to prevent the condensation of steam within a mat during the preparation of same. In this embodiment, heated carbon dioxide is coinjected with steam and sometime air. The amount of carbon dioxide or carbon dioxide and air coinjected and the temperature of the carbon dioxide or carbon dioxide and air is controlled such that the dew point of the steam and carbon dioxide or steam, air, and carbon dioxide is higher than the temperature of the mat to prevent condensation.

In this embodiment, the term hot or heated carbon dioxide means carbon dioxide having a temperature of at least 125° C. and an upper temperature such that the temperature of the cellulosic material of a mat being produced with a method of the application does not exceed 300° C.

One advantage of the method of the application is that a faster cure can be achieved which in turn allows for a shorter cycle time and energy savings. Another advantage is that higher strength properties can be achieved. Still another advantage of the method of the application is a reduction in the amount of binder used. All of these elements offer a significant economic advantage over the prior art.

In some embodiments, the systems used to prepare the cellulosic articles will include steam injection. This is particularly true where isocyanates are used as part of the curing agent. It is well known in the art of producing cellulosic materials that isocyanates are good binding agents, but present problems such as requiring mold release agents during production. Since steam would no longer be needed in in a steamless press bonding system, it may be possible to avoid the use of isocyanates in some applications.

One advantage of the method of the application is that steam may be eliminated and additional heat may be introduced to the system using the heated carbon dioxide. The heat capacity Cₚ of carbon dioxide is 0.84 while the heat capacity water (at 100° C.) is 4.18. As a consequence, more carbon dioxide may be required or else heated to a higher temperature as compared to steam.

In the practice of the method of the application, carbon dioxide may be added at one or more of the following locations within a press bonding system: the blender where binder is added to the cellulosic material; the conveyor belt running to the forming bunker; the forming bunker itself; out-feed from the forming bunker; the forming line; the steam preheater; directly to the press; and for those systems employing a perforated platen, to the press via the platen perforations.

In one embodiment of the method of the application, the carbon dioxide employed during the press cycle can be recovered and reused. This is accomplished using any subsystem known to be useful to those of ordinary skill in the art to be useful for recovering gasses, especially carbondioxide. Additionally, other greenhouse gasses may also be recovered. This may represent an environmental advantage over conventional processes.

In any method of the application, air may be included as a separate injection component or mixed with the heated carbon dioxide or steam used with the methods of the application.

### EXAMPLES

The following examples are provided to illustrate the invention. The examples are not intended to limit the scope of the invention and they should not be so interpreted. Amounts are in weight parts or weight percentages unless otherwise indicated. Molecular weights, if any, are determined by GPC and are M_{w}.

For each example, a cellulosic mat (maple veneer) was tested with a Gas Automated Bond Evaluation System (G-ABES). The G-ABES apparatus has a chamber close force of 36 psi, gas treatment force of 42 psi and max pressing force of 82 psi. The platen chamber supporting the mat was heated to 130° C. The mat was cut to the dimensions of 0.59 inches in length by 0.79 inches in width and placed into specimen clamps. Phenol formaldehyde resin polymers were applied to 0.2 inch of the veneer at a treatment of 5 milligram (mg) +/−1 mg to one side. A treated matt section and an untreated mat section were placed in the instrument and the chamber was closed. In the examples detail below, the specimens were treated with different gases (Control, Air, and Carbon dioxide) for a treatment time of 30 sec, followed by a max pressing force and pulled apart. In addition, different gas flow rates (23 mL/min and 50 mL/min) and gas temperatures (70° C. and 150° C.) were evaluated. The pull force was calculated in psi. Each condition was repeated 5 times and the results averaged.

### Example 1

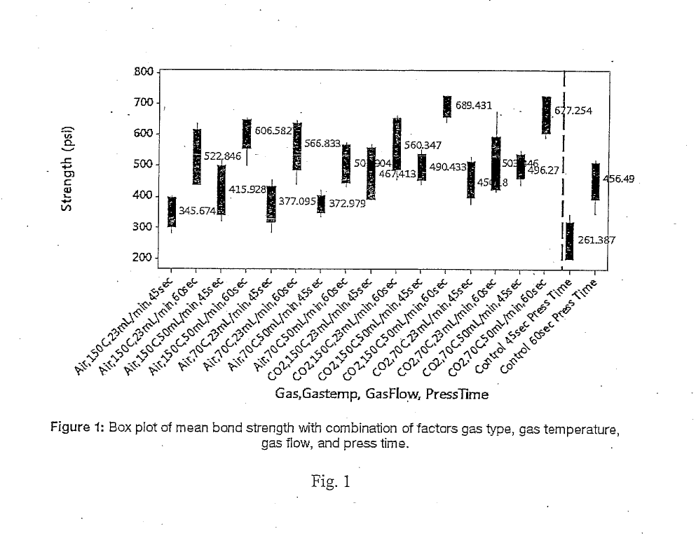

Mean bond strength was determined as a function of gas type, gas temperature, gas flow, and press time. The results are displayed in FIG. 1.

### Example 2

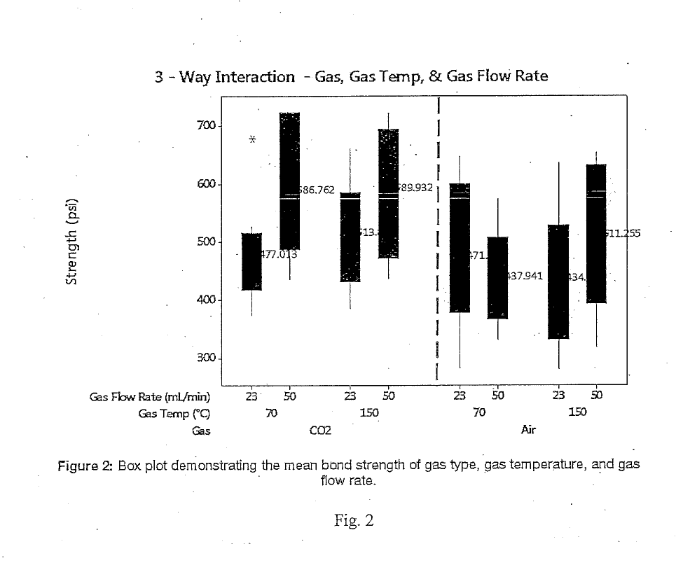

Mean bond strength was determined as a function of gas type, gas temperature, and gas flow rate. The results are displayed in FIG. 2.

### Example 3

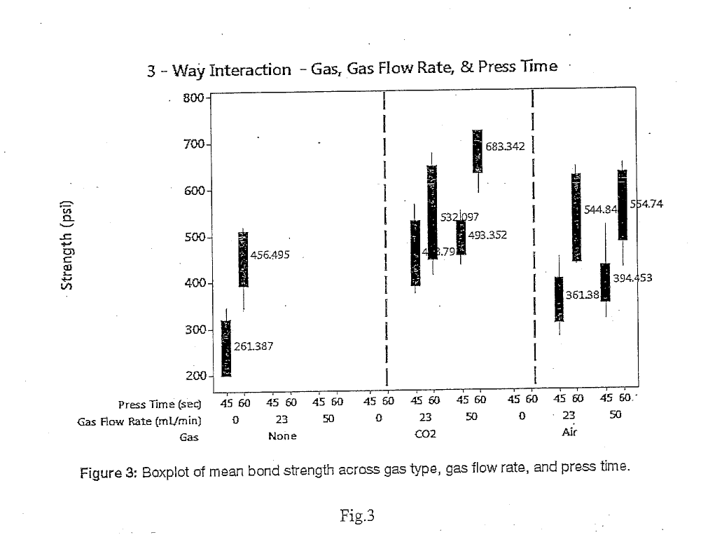

Mean bond strength was determined as a function of gas type gas flow rate and press time. The response results are displayed in FIG. 3.

### Discussion of the Results

The results of the testing indicated that the pull force of the invention provided for a 16 to 50% increase in bond performance over conventionally produced cellulosic mats. Such improvements in a commercial process would result in substantial improvements to cycle time.

What is claimed is:

1. A method for press bonding lignocellulosic material with phenol formaldehyde resin and carbon dioxide comprising heating the carbon dioxide prior to introducing the carbon dioxide into a press bonding system.

2. The method of claim 1 wherein steam is employed to introduce heat into the press bonding system.

3. The method of claim 2 wherein carbon dioxide is employed to introduce heat into the press bonding system.

4. The method of claim 1 wherein carbon dioxide is employed to introduce heat into the press bonding system and no steam is employed there with.

5. A press bonding system comprising a heated press and one or more elements selected from the group consisting of:
a blender where binder is added to cellulosic material;
a conveyor belt running to a forming bunker;
a forming bunker;
an out-feed from the forming bunker;
a forming line; and
a steam preheater;
wherein at least one of the one or more elements is configured to receive heated carbon dioxide.

6. The press bonding system of claim 5 further comprising a carbon dioxide preheater.

7. The press bonding system of claim 5 wherein the press includes a perforated platen and the perforated platen is configured to receive heated carbon dioxide.

8. The press bonding system of claim 5 wherein the system is configured to recover and recycle carbon dioxide.

9. The press bonding system of claim 5 further comprising a subsystem, located downstream from the press, which is configured to recover carbon dioxide or other gasses.

10. A method for press bonding lignocellulosic material with phenol formaldehyde resin and carbon dioxide comprising heating the carbon dioxide prior to introducing it into a press bonding system and carbon dioxide is employed to introduce heat into the press bonding system wherein a lignocellulosic material is produced and is selected from the group consisting of plywood, laminated veneer lumber (LVL), oriented strand lumber (OSL), oriented strand board (OSB), particleboard, medium density fiber board, and hardboard.

11. The method of claim 10 wherein the lignocellulosic material is oriented strand board.

12. The method of claim 10 wherein the carbon dioxide is recovered for reuse.

13. A method for press bonding lignocellulosic material with phenol formaldehyde resin and carbon dioxide comprising:
heating the carbon dioxide prior to introducing it into a press bonding system, wherein the carbon dioxide is heated to a temperature of from about 125° C. to a temperature where any steam used in the process does not condense within or onto the lignocellulosic material.

14. The method of claim 1, claim 10, or claim 13 wherein hot air and/or steam is coinjected with the heated carbon dioxide.
